(19) United States
(12) Patent Application Publication
(10) Pub. No.: US 2006/0270298 A1
(43) Pub. Date: Nov. 30, 2006

(54) Textured and printed membrane that simulates fabric

(75) Inventors: William Kuhn, Stonington, CT (US); Peter Burnett, Cohasset, MA (US); Jim Labonte, Warwick, RI (US)

Correspondence Address: DOUGHERTY CLEMENTS, 1901 ROXBOROUGH ROAD, SUITE 300, CHARLOTTE, NC, 28211, US

(73) Assignee: Cooley, Incorporated

(21) Appl. No.: 11/440,844

(22) Filed: May 25, 2006

Related U.S. Application Data
(60) Provisional application No. 60/684,316, filed on May 25, 2005.

(51) Int. Cl. B32B 29/02

(52) U.S. Cl. 442/260; 442/261; 442/288; 442/290; 442/291

(57) ABSTRACT

A textured and printed membrane has an embossed top layer with a protective coating, a fabric layer, a printed bottom layer with a protective coating, where the layers are adhered with a PVC plastisol. The printing pattern matches the embossing, such that the membrane has the appearance of cloth on both sides. The textured vinyl membrane composite has a thickness of from 10 to 35 mils. The membrane can be fitted on an awning to display illuminated (white/opaque) graphics (lettering or design). The top layer is preferably compounded PVC formulated with a colorant. The bottom layer is also PVC, typically formulated with a flame retardant package, such as antimony trioxide or brominated compounds, aluminum trihydrate, magnesium hydroxide, and the like to suppress the spread of an ignited flame. Both top and bottom layers can have heat stabilizers and lubricants to improve processing of the PVC.

### CROSS-REFERENCE TO RELATED PATENT APPLICATION

The application claims the benefit of the priority filing date of the Provisional Patent Application bearing Ser. No. 60/684,316, which was filed on May 25, 2005.

### BACKGROUND OF THE INVENTION

(1) Field of the Invention

The present invention relates to embossed vinyl membranes and their manufacture. The invention relates more particularly to embossed awnings that are backlit for business use.

(2) Prior Art

The majority of awnings used by businesses in the market place are either dyed acrylic fabric or vinyl. A weakness of cloth awnings is that they are water resistant, not waterproof, and fungus and mildew can penetrate into the interstices of the cloth and discolor the cloth. Many of the vinyl awnings are backlit (for instance, those used by Blockbuster Video and various pizza stores). Nearly all such vinyl awnings are smooth. The few vinyl awnings that are embossed are used strictly for front-lit applications, and the backside does not have the esthetic appeal of cloth, which is substantially similar in appearance on both sides. There is no known use of vinyl embossed awnings where both sides of the awnings look and feel exactly like cloth.

### SUMMARY OF THE INVENTION

The invention is a textured waterproof membrane that is suitable for displays, awnings and other applications, where it is highly desired that the material looks like fabric, but has the weather, mold and mildew resistance, and an ease of cleaning that is only obtainable with certain polymeric membrane materials. The textured membrane is substantially a laminate, comprised of a flexible polymeric top layer having an embossed front side; a fabric layer; and a flexible polymeric bottom layer having a printed bottom side with a printed layer of ink. The laminate can be further comprised of: a coextensive adhesive, where the coextensive adhesive extends from the bottom layer through the fabric layer to the top layer. The coextensive adhesive bonds all the layers into a unified membrane. Generally speaking, if the membrane is extruded, then a coextensive adhesive is not needed to bond the top layer and the bottom layer. Additionally, the top layer is coated with a polymer having resistance to weathering, staining, and plasticizer, and the printed bottom layer has a coating to protect the printing, and provide additional resistance to weathering, staining, and plasticizer migration.

The printing and the embossing are selected to simulate cloth, in both appearance and feel, such that the membrane is visually, substantially indistinguishable from cloth. Typically, the simulated cloth mimics sailcloth or another woven cloth, where the cloth has historically been employed in outdoor applications. The top and bottom layers of the membrane can be comprised of any flexible polymeric material that can be laminated to, or through, the fabric. Exemplary polymeric materials are plasticized polyvinylchloride (PVC), polyurethane, polyester, polyamide, halogenated polyolefins, hydrogenated polyisoprene, hydrogenated polybutadiene, hydrogenated ethylene polybutadiene, hydrogenated styrene ethylene polybutadiene block copolymers, certain flexible grades of polyolefin, EVA, EVOH, certain grades of thermoplastic block copolymers, polycaprolactones, polyacrylates and the like compounded for color, weather resistance and flammability. The fabric layer is typically a reinforced fabric, preferably comprised of a polyester yarn, polyamide yarn, a polyimide yarn, a polyethylene yarn, an acrylic yarn, a glass yarn, an aramid yarn, a cotton yarn, and blends thereof, where the yarn is selected to impart a desired degree of reinforcement, flexibility and cost. The fabric layer is embedded in the laminated layers, and adds very little to the overall texture and appearance of the membrane. When the top and bottom layers are comprised of PVC, then the coextensive adhesive is preferably a PVC plastisol, which during processing is converted into a continuous PVC film by application of heat. When the top and bottom layers are comprised of polyurethane then the coextensive adhesive is preferably a curing urethane. The coextensive is selected to penetrate the fabric and to bond the top and bottom layers. The top and bottom layers can further more have tie coats, sometimes referred to as bond coats to improve the adhesion between the coextensive and top and bottom layers.

The membrane can be fitted with PSV (pressure sensitive vinyl) graphics or digitally inkjet printed for external decoration. In backlit applications, the top layer is clear or translucently colored, and the top layer is printed. If the printing covers the entire layer, then backlit graphics can be formed by eradicating the printed ink. The eradicated ink forms a graphic design, which when backlit is translucent. Application of a PSV can then optionally be added to change the color of the graphic, and still produce a backlit membrane.

### OBJECTS OF THE INVENTION

The principal object of the present invention is to provide a textured membrane that has the look and feel of fabric.

Another object of this invention is to provide a waterproof material that has excellent weatherability, and resistance to staining, fungus, mildew and ultraviolet light.

Another object of this invention is to provide a textured material that has the strength, puncture resistance, and non-flammability to be suitable for an outdoor awning.

A further object of this invention is to provide a textured material that can be decorated using PS vinyl graphics, silk screen printing, digital printing, ink and templates, stitched graphics, graphics formed from the invented membrane, and free-hand painting.

### BRIEF DESCRIPTION OF THE DRAWINGS

The foregoing and other objects will become more readily apparent by referring to the following detailed description and the appended drawing in which:

FIG. 1 is an exploded view of the invented membrane;

FIG. 2 is an elevational perspective side view of the embossed waterproof vinyl membrane;

FIG. 3 is a planar view of the bottom of the invented printed embossed membrane;

FIG. 4 is a planar view of the top of the invented printed embossed membrane, wherein the membrane is fitted with a PSV graphic;

FIG. 5 is an exploded view of the invented membrane having protective coatings on the covering of the embossed top layer of vinyl, and the printed top layer of vinyl;

FIG. 6 is a perspective view of the invented membrane fabricated into an awning; and

FIG. 7 is an exploded view of an embodiment of the invented membrane, wherein top and bottom layers are extruded onto the reinforcing fabric.

### DETAILED DESCRIPTION

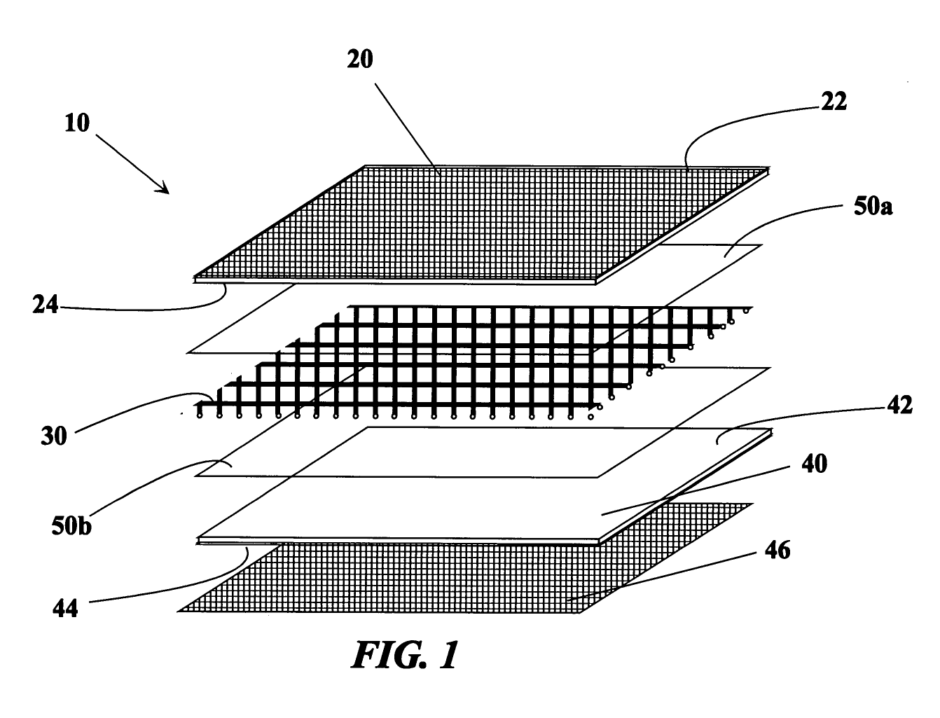

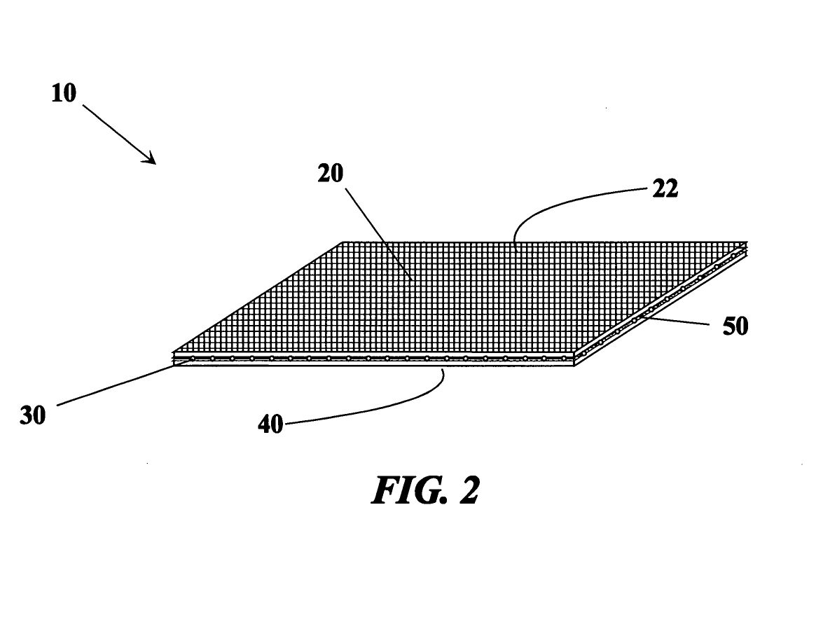

The invention is a textured waterproof membrane 10 that is suitable for displays, awnings and other applications, where it is highly desired that the material looks like fabric, but has the weather, mold and mildew resistance, and cleanability that is only obtainable with certain polymeric membrane materials. The textured membrane 10 is substantially a laminate, and as shown in FIG. 1, the laminate is comprised of a plasticized PVC top layer 20 having an embossed front side 22 and a reverse side 24; a fabric layer 30; a plasticized PVC bottom layer 40 having a forward side 42 and a printed bottom side 44 with a printed layer of ink 46; and a coextensive adhesive 50 (50a+50b), where the coextensive adhesive 50 extends from the bottom layer 40 through the fabric layer 30 to the top layer 20. The coextensive adhesive 50 is a PVC plastisol, and it bonds all the layers into the unified textured waterproof membrane 10, as shown in FIG. 2. As can be seen, the PVC plastisol 50 permeates the fabric 30, and extends in the form of a plasticized PVC film from the top layer 20 to the bottom layer 40. The PVC plastisol 50 can be applied in one heavy coating or two less heavy applications, and upon lamination the plastisol is heated to a point where the phase separation breaks down, therein forming an excellent adhesive.

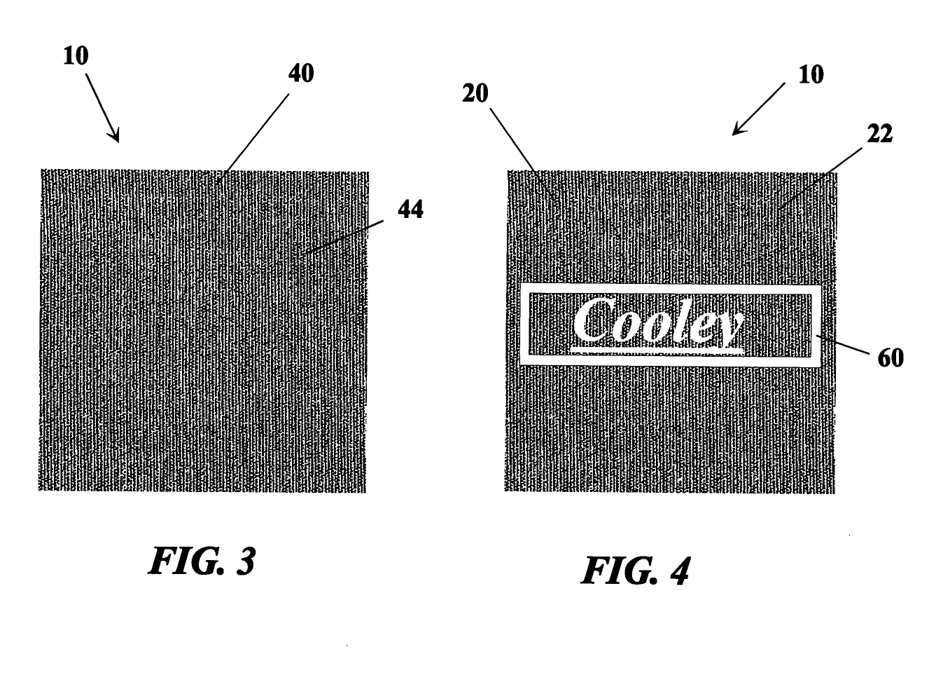

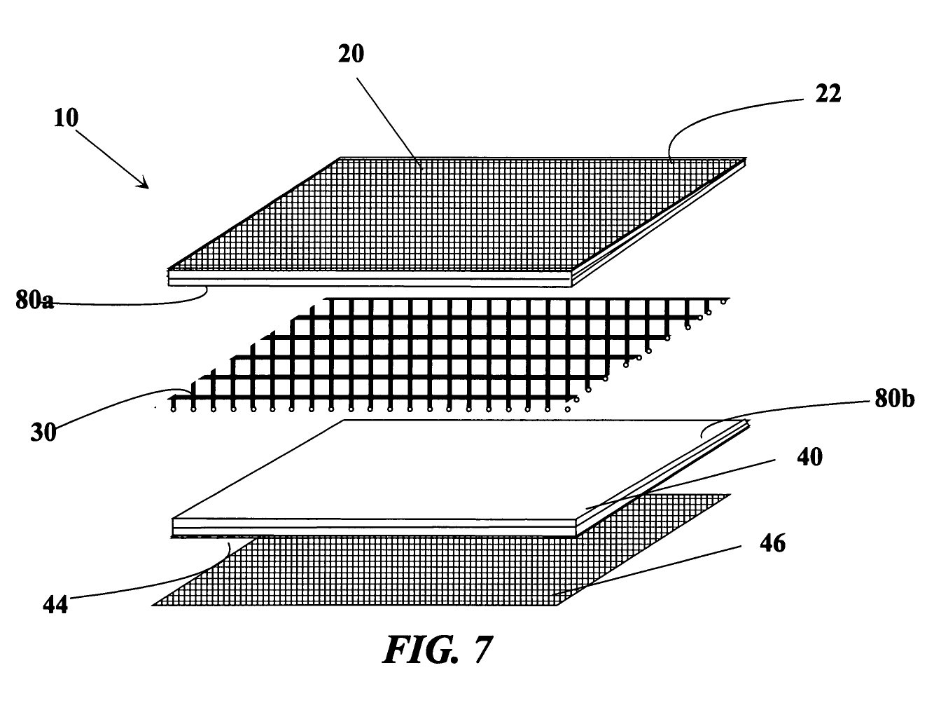

Alternatively, as illustrated in FIG. 7, the membrane can be formed using a cast extrusion process, wherein the fabric is embedded in the top and bottom layers. No coextensive adhesive is required as the top and bottom layers bond to each other during extrusion. A layer can be extruded as a single layer material, or coextruded with a tie-layer. Typically, a tie-layer is added to improve the bond between the two layers and to the cloth. Using the example of PVC, the top and bottom layers could be coextruded with one or both having a tie-layer that has a higher plasticizer content to improve adhesion. In FIG. 7 the coextruded tie-layer is identified as 80a on the top and 80b on the bottom. When the membrane is extruded or coextruded with a tie-layer, and the top and bottom layers are bonded to each other and to the fabric, then the coextensive adhesive and lamination process are not needed. The printing and the embossing are selected to simulate cloth, both in appearance and feel, such that visually the membrane is substantially indistinguishable from cloth, and this is illustrated more realistically in FIGS. 3 and 4. The printed layer of ink 46 printed on bottom side 44 of the bottom layer matches the embossing pattern on the front side 22 of the top layer 20. Typically, the simulated cloth mimics sailcloth or another woven cloth, where such cloth historically has been employed in outdoor applications. The fabric layer is a reinforced fabric selected to impart the desired degree of reinforcement. The fabric layer is embedded in the PVC layers, and adds very little to the overall texture and appearance of the membrane. The reinforced fabric is composed of a polyester, such as polyethylene terephthalate (PET) that is PET weft inserted knit yarn, with a tenacity of 250 to 1500 denier, preferably about 500. Aramid fabrics can be used in conjunction or separate to add superior strength. Woven and nonwoven yarns can also be used. The reinforced fabric has 1 to 36 yarns per inch in each warp and fill (machine and cross machine) direction, preferably 18 in the warp and 12 in the fill direction.

The invented textured and printed flexible membrane has a thickness of 2 to 50 mils, but preferably a thickness of 10 to 35 mils. The top layer of plasticized PVC contains a colorant to produce the desired color of the simulated cloth. If the membrane is to be used in backlit applications, then the color intensity is kept such that the top layer is translucent. The bottom layer is white or translucent vinyl, and can have a flame retardant package, such as antimony trioxide or brominated compounds, aluminum trihydrate, magnesium hydroxide, and the like incorporated therein. Both top and bottom layers typically contain heat stabilizers and PVC processing aids, and UV stabilizers for added protection.

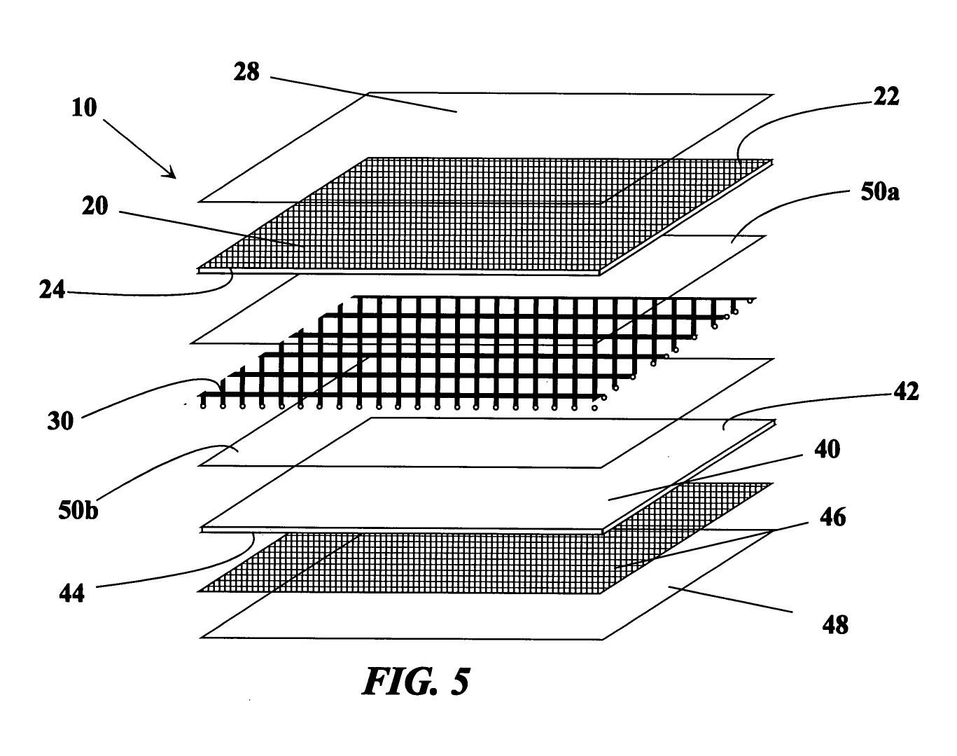

The top layer of flexible polymeric material, PVC preferably, can have a protective topcoat 28 of a polymer having resistance to weathering, staining, and plasticizer migration, as illustrated in FIG. 5. The polymer of the top coat is selected from the group consisting of acrylic polymers, acrylic copolymers, acrylic terpolymers, methacrylic polymers, methacrylic copolymers, methacrylic terpolymers, acrylonitrile polymers, acrylonitrile copolymers, acrylonitrile terpolymers, fluorinated polymers, fluorinated copolymers, fluorinated terpolymers, chlorofluro polymers, chlorofluro copolymers, chlorofluro terpolymers, polyamide polymers, polyamide copolymers, polyamide terpolymers, aliphatic polymers, aliphatic copolymers, aliphatic terpolymers, urethane polymers, urethane copolymers, and urethane terpolymers. The preferred polymer of the topcoat is polyvinyl acrylate copolymer. The bottom layer of the flexible polymeric material, PVC preferably, also can have a protective bottom coat 48, to provide improved weathering, staining, reduce plasticizer migration, and to protect the layer of printing ink 46 from the elements. The coating on the bottom 48 is typically the same polymer as used in the topcoat 28. Dulling agents can be added to either topcoats to lower the gloss reading to a matte or dull level to better simulate cloth or fabric appearance.

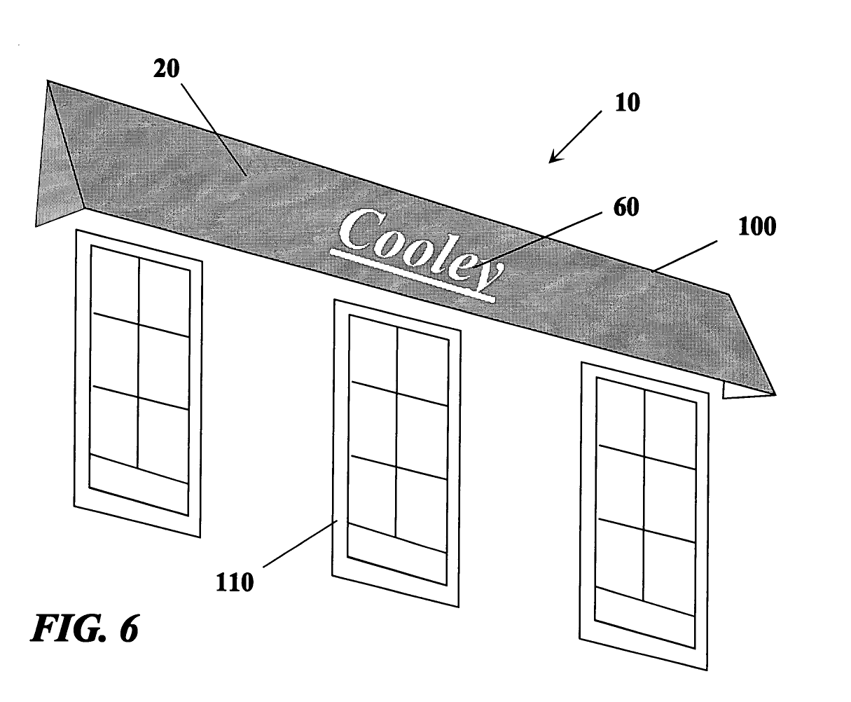

The front of the membrane 10 can be fitted with graphics (lettering or design), such as a pressure sensitive vinyl (PSV) graphic. FIG. 4 illustrates a PSV 60, which is a colored PVC film having a weather resistant adhesive. A PSV graphic 60 is also illustrated in FIG. 6, where the invented membrane 10 is an awning. The graphic can also be created using silkscreen printing, digital printing, ink and templates, stitched graphics, graphics formed from the invented membrane, and free-hand painting. A similar graphic can be created for backlit applications, by eradicating ink printing on the top layer. Ink eradication is performed using a stencil mask and a solvent, such as Cooley Magic solvent and Cooley Mask. The ink is removed using lint free rag to wipe away the solvent layer clear or translucently colored, and the top layer is printed. If the printing covers the entire layer, then backlit graphics can be formed by eradicating the printed ink. The eradicated ink creates the graphic.

The invented textured vinyl membrane has a composition, by weight percent, of:
from about 20% to about 80% PVC:
from about 0% to about 75% plasticizer;
from about 0% to about 50% of filler;
from about 0% to about 20% of color concentrate;
from about 0% to about 20% of flame retardant;
from about 1% to about 20% of vinyl stabilizer; and
from about 0.1% to about 2% of thermal/UV stabilizer/processing aides; and
from about 5% to about 50% of reinforcing fabric; and
from about 0% to about 1% of anti-microbial or anti-fungal agent.

In the following example the top layer comprises formulated PVC, having a plasticizer and UV stabilizers. Table 1 illustrates the properties of a typical awning material. The membrane is textured 16-ounce PVC composite without the intrinsic weaknesses of woven fabric. It is currently available in widths up to 76″, allowing for greater design flexibility and improved productivity during fabrication. It is easy to handle and durable throughout the fabrication process and it resists stretching and sagging.

TABLE 1

| 1.0 APPLICATION | AWNINGS | |
|---|---|---|
| 1.1 Top Coating | Acrylic | |
| 1.2 Material Color | Colored Face/Fabric Patterned Color Matched Back | |
| 1.3 Decorative Methods | P.S. Vinyl*, Silk Screen, Spray Paint, Digital Printing | |
| 2.0 BASE FABRIC | U.S. ENGLISH | METRIC |
| 2.1 Weight | 2.9 oz./yd.² | 68.7 g./m.² |

| | |
|---|---|
| 2.2 Fiber | Polyester |
| 2.3 Fabric Style | Weft Inserted |

3.0 COATED FABRIC

| 3.1 Total Weight | 16.0 oz./yd.² | 454.0 g./m.² |
|---|---|---|
| 3.2 Gauge | 0.020 in. | 0.051 cm. |
| 3.3 Type of Coating | PVC | |
| 3.4 Coating Distribution | 55/45 | |
| 3.5 Width | 76.0 in. | 193.0 cm. |
| 3.6 Sealing Properties | Stitching, Dielectic, or Thermal | |
| 4.0 MECHANICAL | | TESTMETHOD/ |
| PROPERTIES | U.S. ENGLISH | ASTM |
| 4.1 Tensile Strength | | |
| Grab Warp | 257.0 lbs. | D751-A |
| Fill | 149.0 lbs. | D751-A |
| 1″ Strip Warp | 176.0 lbs./in. | D751-B |
| Fill | 94.0 lbs./in. | |
| 4.2 Adhesion R.F. | 10.0 lbs./in. | D751 |
| 4.3 Adhesion Thermal | 10.0 lbs./in. | D751 |
| 4.4 Tear Strength, | 55.0 lbs. | D1004-Mod |
| Tongue Warp Fill | 57.0 lbs. | D1004-Mod |
| 4.5 Low Temperature | −40.0° F. | D2136 |
| 4.6 High Temperature, | 180/200° F. | D1204 |
| Cont/Interm. | | |
| 4.7 Puncture | | |
| Screwdriver | 50 lbs. | D751-Mod |
| Ball | 250 lbs. | D751 |
| 4.8 Hydro Resistance | 330 psi. | D751-A |
| 4.9 Abrasion Resistance | Wheel H18 Load 1000 g. | |
| (Taber) To Exposed | Cycles 500 wt loss | D3884 |
| Fabric (Face) | 0.09000 g./cy. | |

The awning membrane of Table 1 is suitable for a variety of awning applications, including residential, retail, restaurant and hospitality, office buildings and other establishments. The textured waterproof membrane has stain-resistant properties not available in woven fabrics, yet the membrane looks like a woven cloth on both sides of the membrane.

The invented membrane offers excellent weatherability, resisting fungus and ultraviolet rays, and is digitally printable. In all applications, it keeps its new appearance with minimal care. It can meet fire specifications such as UL48 and UL94, California State Fire Marshal Title 19 Section 1237, NFPA 701 and/or ASTM E84. Cloth Awnings need to add a special flame resistant coating to pass these specifications.

### SUMMARY OF THE ACHIEVEMENT OF THE OBJECTS OF THE INVENTION

From the foregoing, it is readily apparent that we have invented a reinforced vinyl membrane that has the look and feel of cloth, and yet still has the performance properties only achievable by certain filmic materials. The textured membrane has the strength of cloth, but unlike cloth which is water resistant, the membrane is waterproof, stain and fungus resistant, and has excellent weathering properties. The membrane can be decorated with graphics and fabricated using technology that is utilized for both cloth and vinyl materials. The cloth awnings can be dielectrically or thermally sealed when joining panels together. The membrane has a reinforced fabric that is selected to provide the level of strength suitable for awnings and other applications.

It is to be understood that the foregoing description and specific embodiments are merely illustrative of the best mode of the invention and the principles thereof, and that various modifications and additions may be made to the apparatus by those skilled in the art, without departing from the spirit and scope of this invention,

We claim:

1. A textured and printed membrane, said membrane comprising:
a flexible polymeric top layer, wherein said flexible polymeric layer has a textured front side and a reverse side;
a fabric layer having a first side and a second side, wherein said first side of the fabric layer is adhered/bonded to the reverse side of the flexible polymeric layer; and
a flexible polymeric bottom layer having a forward side and a printed bottom side with a printed layer of ink, wherein said forward side of the flexible polymeric bottom layer is adhered/bonded to the second side of the fabric layer or through the fabric to the top layer.

2. The textured and printed membrane according to claim 1, wherein said textured membrane further comprises:
a top coat of a polymer having resistance to weathering, staining, and plasticizer migration, wherein said top coat is coated on the textured front side of the flexible polymeric top layer.

3. The textured and printed membrane according to claim 2, wherein said textured membrane further comprises:
a bottom coat of a polymer having resistance to weathering, staining, and plasticizer migration, wherein said bottom coat is coated on the bottom side of the flexible polymeric bottom layer.

4. The textured and printed membrane according to claim 2, wherein said textured membrane further comprises:
a coextensive adhesive, wherein said coextensive adhesive extends from the forward side of the flexible polymeric bottom layer through the fabric layer to the reverse side of the flexible polymeric top layer.

5. The textured and printed membrane according to claim 2, wherein said textured membrane further comprises:
a tie-coat layer that is coextruded with the reverse side of the flexible polymeric top layer, wherein said improves adhesive to fabric and the flexible polymeric printed bottom.

6. The textured and printed membrane, as claimed in claim 1, wherein said textured front side of the flexible polymeric top layer is embossed, having the appearance of a woven cloth.

7. The textured and printed membrane, as claimed in claim 1, wherein said membrane is waterproof.

8. The textured and printed membrane, as claimed in claim 1, wherein said flexible polymeric top layer is selected from the group consisting of plasticized polyvinylchloride (PVC), polyurethane, polyester, polyamide, halogenated polyolefins, hydrogenated polyisoprene, hydrogenated polybutadiene, hydrogenated ethylene polybutadiene, hydrogenated styrene ethylene polybutadiene block copolymers, certain flexible grades of polyolefin, EVA, EVOH, certain grades of thermoplastic block copolymers, polycaprolactones, polyacrylates and the like.

9. The textured and printed membrane, as claimed in claim 8, wherein said flexible polymeric top layer is comprised of PVC.

10. The textured membrane, as claimed in claim 9, wherein said flexible PVC top layer is further comprised of a colorant.

11. The textured and printed membrane, as claimed in claim 6, wherein said printed bottom side of the flexible polymeric bottom layer has a print pattern that matches the embossing on the front side of the flexible polymeric top layer, the combined embossing and printing making the textured membrane visually substantially indistinguishable from cloth.

12. The textured and printed membrane, as claimed in claim 9, wherein said flexible polymeric bottom layer is comprised of polyvinyl chloride (PVC).

13. The textured and printed membrane, as claimed in claim 4, wherein said coextensive adhesive is a PVC plastisol, which is converted into a plasticized PVC film during fabrication of the membrane.

14. The textured and printed membrane, as claimed in claim 2, wherein said polymer of the top coat is selected from the group consisting of acrylic polymers, acrylic copolymers, acrylic terpolymers, methacrylic polymer, methacrylic copolymers, methacrylic terpolymers, acrylonitrile polymers, acrylonitrile copolymers, acrylonitrile terpolymers, fluorinated polymers, fluorinated copolymers, fluorinated terpolymers, chlorofluro polymers, chlorofluro copolymers, chlorofluro terpolymers, polyamides polymers, polyamides copolymers, polyamides terpolymers, aliphatic polymers, aliphatic copolymers, aliphatic terpolymers, urethane polymers, urethane copolymers, and urethane terpolymers.

15. The textured and printed membrane, as claimed in claim 14, wherein said polymer of the top coat is polyvinyl acrylate copolymer.

16. The textured and printed membrane, as claimed in claim 3, wherein said polymer of the bottom coat is selected from the group consisting of acrylic polymers, acrylic copolymers, acrylic terpolymers, methacrylic polymer, methacrylic copolymers, methacrylic terpolymers, acrylonitrile polymers, acrylonitrile copolymers, acrylonitrile terpolymers, fluorinated polymers, fluorinated copolymers, fluorinated terpolymers, chlorofluro polymers, chlorofluro copolymers, chlorofluro terpolymers, polyamides polymers, polyamides copolymers, polyamides terpolymers, aliphatic polymers, aliphatic copolymers, aliphatic terpolymers, urethane polymers, urethane copolymers, and urethane terpolymers.

17. The textured and printed membrane, as claimed in claim 2, wherein said top coat is further comprised of a dulling agent to impart a matte finish.

18. The textured membrane, as claimed in claim 16, wherein said polymer of the bottom coat is polyvinyl acrylate copolymer.

19. The textured and printed membrane, as claimed in claim 3, wherein said bottom coat is further comprised of a dulling agent to impart a matte finish.

20. The textured and printed membrane, as claimed in claim 1, wherein said fabric layer is a reinforced fabric comprised of polyester.

21. The textured and printed membrane, as claimed in claim 1, wherein said reinforced fabric has a denier of 250 to 1500, preferably about 500.

22. The textured and printed membrane, as claimed in claim 12, wherein said flexible PVC bottom layer is further comprised of a flame retardant.

23. A textured and printed membrane, having a composition, by weight percent, comprising:
from about 20% to about 80% PVC;
from about 0% to about 75% plasticizer;
from about 0% to about 50% of filler;
from about 0% to about 20% of color concentrate;
from about 0% to about 20% of flame retardant;
from about 1% to about 20% of vinyl stabilizer; and
from about 0.1% to about 2% of thermal/UV stabilizer/processing aides; and
from about 5% to about 50% of reinforcing fabric; and
from about 0% to about 1% of anti-microbial or anti-fungal agent.

24. A textured and printed membrane according to claim 23, having a thickness of 2 to 50 mils.

25. A textured and printed membrane according to claim 24, having a thickness of 15 to 35 mils.

26. A textured and printed membrane according to claim 23, wherein the flame retardant is comprised of antimony trioxide, a brominated compound, aluminum trihydrate, magnesium hydroxide, and the like that suppress the spread of an ignited flame.

27. A textured and printed membrane according to claim 23, wherein the reinforcing fabric has 1 to 36 yarns per inch in each warp and fill (machine and cross machine) direction.

28. A textured and printed membrane according to claim 27, wherein the reinforcing fabric has 18 yarns per inch in the warp direction and 12 yarns per inch in the fill direction.

29. A textured and printed membrane according to claim 27, wherein the reinforcing fabric is comprised of a polyester yarn, polyamide yarn, a polyimide yarn, a polyethylene yarn, an acrylic yarn, a glass yarn, an aramid yarn, a cotton yarn, and blends thereof
